(19) United States
(12) Patent Application Publication
(10) Pub. No.: US 2025/0181518 A1
(43) Pub. Date: Jun. 5, 2025

(54) MANAGEMENT OF DEVICE UTILIZATION

(71) Applicant: Intel Corporation, Santa Clara, CA (US)

(72) Inventors: Maksim LUKOSHKOV, Clarecastle (IE); Mateusz POLROLA, Lodz (PL); Ciunas LOW BENNETT, Mallow (IE); Tomasz KANTECKI, Ennis (IE)

(21) Appl. No.: 19/045,990

(22) Filed: Feb. 5, 2025

(51) Int. Cl. G06F 12/1081; G06F 13/18; G06F 13/42

(52) U.S. Cl. CPC G06F 12/1081; G06F 13/18; G06F 13/4221

(57) ABSTRACT

Examples described herein relate to a device that includes a host interface; circuitry coupled to the host interface; and second circuitry. The second circuitry is to limit usage of the circuitry, by a first process, by limiting performance of requests for translation of virtual memory addresses to physical memory addresses, from the first process. The circuitry includes one or more of: a network interface device, an accelerator, memory, or storage.

Data centers provide processing, storage, and networking resources for customers. For example, automobiles, smart phones, laptops, tablet computers, or internet of things (IoT) devices can leverage data centers to perform data analysis, data storage, or data retrieval. Data centers include processors and devices such as memory, accelerators, network interface devices, and others.

### BRIEF DESCRIPTION OF THE DRAWINGS

FIG. 1 depicts an example system.

FIG. 2 depicts an example operation of a system.

FIG. 3 depicts an example of configuration data.

FIG. 4 depicts an example process.

FIG. 5 depicts an example process.

FIG. 6 depicts an example computing system.

### DETAILED DESCRIPTION

Different processor-executed processes can utilize device bandwidth or operations. However, certain processes can request to utilize device bandwidth to perform operations that violate Service Level Agreement (SLA) parameters associated with the processes. Accordingly, a process that requests device utilization in excess of its SLA can prevent usage of the device by other processes and the process can be considered a noisy neighbor.

Various examples can perform SLA enforcement, at a process-level granularity, to control usage of one or more devices by the process. In some examples, controlling usage of one or more devices by the process can include an Input-Output Memory Management Unit (IOMMU) processor rate limiting Address Translation Services (ATS) for the process. Accordingly, regardless of which device is used by the process, various examples can provide device-agnostic SLA enforcement, to limit usage by devices that use ATS, such as network interface controllers (NICs), accelerators (e.g., encryption, decryption, compression, decompression, direct memory access (DMA), data streaming, or others), graphics processing units (GPUs), neural processing units (NPUs), or others.

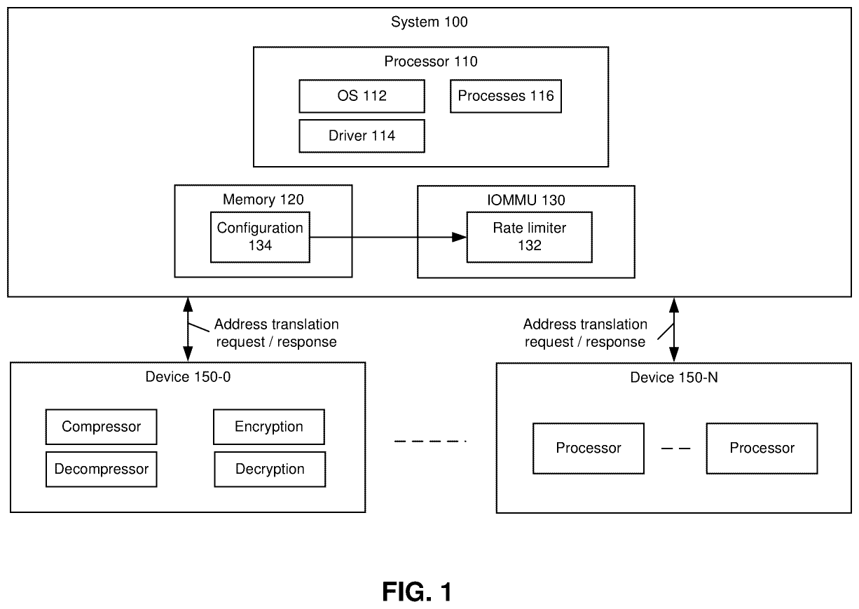

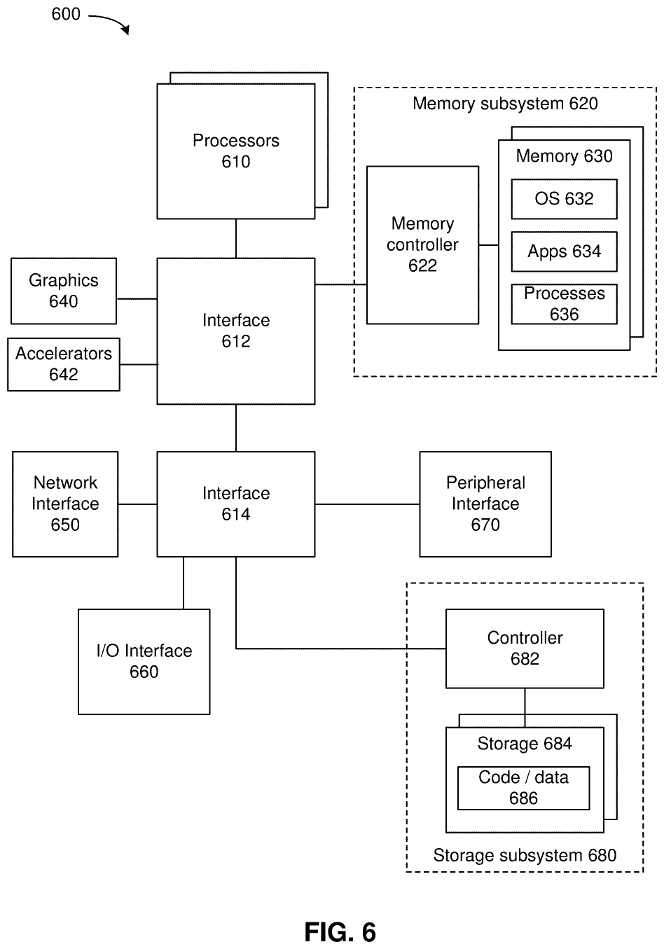

FIG. 1 depicts an example system. System 100 can include processor 110, memory 120, IOMMU 130, and other circuitry and software described at least with respect to FIG. 6. Processor 110 can include one or more of: a central processing unit (CPU), a processor core, graphics processing unit (GPU), neural processing unit (NPU), general purpose GPU (GPGPU), field programmable gate array (FPGA), application specific integrated circuit (ASIC), tensor processing unit (TPU), matrix math unit (MMU), or other circuitry. A processor core can include an execution core or computational engine that is capable of executing instructions. A core can access to its own cache and read only memory (ROM), or multiple cores can share a cache or ROM. Cores can be homogeneous (e.g., same processing capabilities) and/or heterogeneous devices (e.g., different processing capabilities). A core can be sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others.

Processor 110 can execute a process of processes 116 that requests packet processing, packet transmission, data compression, data decompression, data encryption, data decryption, data copying, or other operations to be performed by one or more of devices 150-0 to 150-N, where N is an integer. Processes 116 can include one or more of: application, process, thread, a virtual machine (VM), microVM, container, microservice, virtual function (VF), virtual device, or other virtualized execution environment.

In some examples, processor-executed operating system (OS) 112 or driver 114 can advertise capability of IOMMU 130 to limit utilization of one or more devices by rate limiting address translations for a particular process identifier across one or more devices 150-0 to 150-N. User space applications (e.g., Virtual Machine Manager (VMM)) can issue an API call to OS 112 to configure SLAs for processes managed by the VMM. One or more of processes 116 can be identified by Process Address Space Identifiers (PASIDs) or other identifiers. To limit address translations for a particular process, OS 112 can update parameters in IOMMU's configuration 134. To determine address translation limits for a particular process, OS 112 can query parameters from IOMMU's configuration 134.

For example, OS 112 can call an API to configure IOMMU 130 to regulate a rate of address translation operations based on token or credit consumption. Processor-executed OS 112 or driver 114 can configure IOMMU 130 to perform rate limiting 132 of address translation operations for a particular PASID. IOMMU 130 can maintain, in configuration 134, a record of active PASIDs along with a peak number of tokens available as credits for ATS operations. For example, the API call can configure a Translation Lookaside Buffer (TLB) or cache with configuration 134, that can include: an active PASID value, associated starting token value, token increment amount, ceiling on number of accumulated tokens, a peak number of tokens utilized per address translation, and other values. Rate limiter 132 can perform a token consumption scheme for a PASID to regulate a rate of completion of ATS requests from one or more devices.

Accordingly, IOMMU 130 can perform rate limiting of address translations for multiple devices (e.g., network interface devices, accelerators, memory devices, storage devices, and so forth). Different rate limiting schemes may be applied for different PASID values. For example, a first PASID value may have a higher quality of service (QOS) than a second PASID value. API calls to configure token values for the first PASID value and the second PASID value can allocate more initial tokens, a higher token increment rate, and/or higher ceiling token value for the first PASID value than those of the second PASID value.

Per PASID API configurable parameters in configuration 134 can include: initial token allocation, token replenishment rate per interval (e.g., clock cycles or unit of time), maximum token capacity, or others. For example, to configure rate limiting parameters for a given PASID, an example API can be as follows:
status setPasidSla(PASID, default_tokens, max_tokens, tokens_per_millisecond_increment)

To query current rate limiting parameters for a given PASID, an example API can be as follows:
getPasidSla(PASID)=status, default_tokens, max_tokens, tokens_per_millisecond_increment

An example configuration 134 to store PASID values and associated token values can be as follows.

TABLE 1

| PASID | Initial | Token | Max |
|---|---|---|---|
| value | ATS tokens | increment rate | ATS tokens |
| 0 | 0 | 0 | 0 |
| 1 | 250 | 50 | 500 |
| 2 | 200 | 40 | 400 |
| . . . | . . . | . . . | . . . |
| M | 50 | 20 | 100 |

Rate limiter 132 can monitor available tokens or credits for a process and refresh tokens or credits to control utilization of a device by a particular process by limiting address translations performed for the particular process. One or more of devices 150-0 to 150-N can include one or more processors or circuitries that execute particular processes. A device core or circuitry of a device that executes a particular process and requests address translations but does not receive address translations can stall or remain in an idle state, and can enter lower power mode after a configured amount of time, while waiting for receipt of the address translation. Utilization can indicate frequency of performed operations, number of operations to perform, bandwidth (BW) utilization, or others.

In some examples, IOMMU 130 can increment available ATS tokens or credits per-PASID based on a token increment rate. For example, a token increment can increase the available ATS tokens or credits for a particular PASID by the token increment rate amount per clock cycle or unit of time. PASID values assigned more tokens may not be limited in a rate of address translations where a rate of address translations is not slowed by available tokens. PASID values assigned no or fewer tokens may be limited in a rate of address translations where tokens are not available for use to perform address translations.

A configured number of tokens can be depleted based on performance of an ATS request for an associated PASID. Based on receipt of an ATS request, rate limiter 132 can update the given PASID's tokens based on a number of tokens depleted by performing the ATS request. If tokens are depleted for a PASID value to zero or another value, rate limiter 132 can pause ATS request processing for that PASID until new tokens are available, up to translation request limit. Other rate limiting scheme can be applied. For example, a parameter in configuration 134 can define a number of tokens that can be utilized per time interval and the token counter resets back to the parameter value after the time interval to limit the number of address translations performed for a requester during a time interval.

For example, for PASID value of 0, the initial tokens can be 0, the token increment rate can be 0, and the maximum tokens can be 0. Accordingly, IOMMU 130 may not perform any ATS requests for the PASID value of 0 as there are no available tokens or credits.

For example, for PASID value of 1, the initial tokens can be 250, the token increment rate can be 50, and the maximum tokens can be 500. Tokens can be incremented at a rate of 50 tokens per a configured number of clock cycles or time interval to a maximum of 500 tokens. Performance of ATS requests for the PASID value of 1 can cause the tokens for the PASID value of 1 to decrease by a configured number of tokens per address translation.

For example, for PASID value of 2, the initial tokens can be 200, the token increment rate can be 40, and the maximum tokens can be 400. Tokens can be incremented at a rate of 40 tokens per a configured number of clock cycles or time interval to a maximum of 400 tokens. Performance of ATS requests for the PASID value of 2 can cause the tokens for the PASID value of 2 to decrease by a configured number of tokens per address translation.

For example, for PASID value of M, the initial tokens can be 50, the token increment rate can be 20, and the maximum tokens can be 100. Tokens can be incremented at a rate of 20 tokens per a configured number of clock cycles or time interval to a maximum of 100 tokens. Performance of ATS requests for the PASID value of M can cause the tokens for the PASID value of M to decrease by a configured number of tokens per address translation.

IOMMU 130 can connect a direct memory-access-capable (DMA-capable) I/O bus to memory 120. IOMMU 130 can map virtual addresses (e.g., device addresses or memory mapped input/output (I/O) addresses) to physical memory addresses. IOMMU 130 can perform I/O device assignment for assigning I/O devices to processes 116. IOMMU 130 can perform Direct Memory Accesses (DMA) remapping for supporting address translations for DMA operations from devices. DMA operations can include data copy operations that are offloaded from a processor to IOMMU 130. IOMMU 130 can perform interrupt remapping for supporting isolation and routing of interrupts from devices and external interrupt controllers to appropriate processes. IOMMU 130 can perform interrupt posting for delivery of virtual interrupts from devices and external interrupt controllers to virtual processors. IOMMU 130 can perform recording and reporting of DMA and interrupt errors to system software that may otherwise corrupt memory or impact process isolation.

Devices 150-0 to 150-N can perform operations offloaded from processor 110. Devices 150-0 to 150-N can include one or more processors or circuities that can be assigned to perform operations for one or more different processes. One or more of the device processors or circuitries can request address translations for a particular process, subject to rate limiting, as described herein. For example, devices 150-0 to 150-N can perform one or more of: data compression, data decompression, data encryption, data decryption, data copy offload, or other operations. In some examples, devices 150-0 to 150-N can include a network interface device. A network interface device can include one or more of: a network interface controller (NIC), a remote direct memory access (RDMA)-enabled NIC, SmartNIC, router, switch, forwarding element, infrastructure processing unit (IPU), data processing unit (DPU), edge processing unit (EPU), or Amazon Web Services (AWS) Nitro Card. An edge processing unit (EPU) can include a network interface device that utilizes processors and accelerators (e.g., digital signal processors (DSPs), signal processors, or wireless specific accelerators for Virtualized radio access networks (vRANs), cryptographic operations, compression/decompression, and so forth). A Nitro Card can include various circuitry to perform compression, decompression, encryption, or decryption operations as well as circuitry to perform input/output (I/O) operations.

In some examples, system 100 can be implemented as part of a system-on-a-chip (SoC). Various examples of system 100 can be implemented as a discrete device, in a die, in a chip, on a die or chip mounted to a circuit board, in a package, or between multiple packages, in a server, in a CPU socket, or among multiple servers. Processor 110 can access one or more of devices 150-0 to 150-N by device interfaces such as Peripheral Component Interconnect express (PCIe), Compute Express Link (CXL), or others.

Processor 110 can access one or more of devices 150-0 to 150-N by die-to-die communications; chipset-to-chipset communications; circuit board-to-circuit board communications; package-to-package communications; and/or server-to-server communications. Die-to-die communications can utilize Embedded Multi-Die Interconnect Bridge (EMIB) or an interposer. Components of FIG. 1 (e.g., processor 110, devices 150-0 to 150-N, or others) can be enclosed in one or more semiconductor packages. A semiconductor package can include metal, plastic, glass, and/or ceramic casing that encompass and provide communications within or among one or more semiconductor devices or integrated circuits.

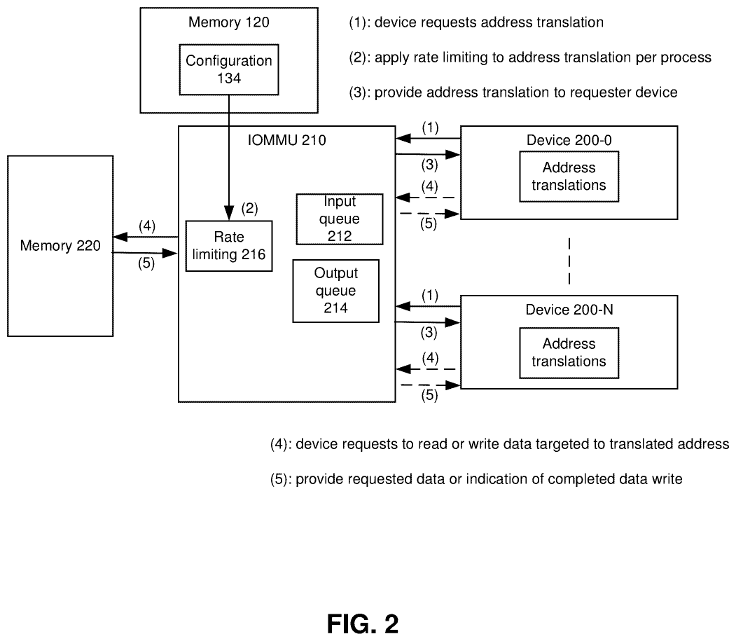

FIG. 2 depicts an example operation of a system. At (1), one or more of devices 200-0 to 200-N, where N is an integer, can request IOMMU 210 to perform address translations from virtual addresses to physical addresses allocated in memory 220. The request to perform address translation can include a reference to a process identifier (e.g., PASID) that requested the device to perform operations. IOMMU 210 can store received requests in input queue 212. IOMMU 210 can select a translation request from input queue 212 on a first-in-first out basis, independent of priority of a requester device or associated PASID.

At (2), IOMMU 210 can utilize rating limiting 216 to limit a rate at which address translations are performed, from one or more of devices 200-0 to 200-N, for a particular PASID. Rate limiting of performance of ATS requests from a PASID can occur by capping a rate of responses to ATS requests based on available tokens for the PASID. At (2), based on a sufficient number of available tokens for the PASID associated with the translation request, IOMMU 210 can perform address translation and provide the address translation to the requester device(s). However, based on unavailability of a token for the PASID associated with the translation request or insufficient number of tokens, IOMMU 210 can buffer the request in input queue 212 until a sufficient number of tokens is available for the PASID. In some examples, to prevent a PCIe Completion Timeout scenario, ATS rate limiting interval can be less than a PCIe Completion Timeout interval for a given Peripheral Component Interconnect express (PCIe) device so that ATS requests are completed within a Completion Timeout interval.

At (3), IOMMU 210 can provide the address translation in output queue 214 to provide the address translation to the device that requested the address translation. In some examples, one or more of devices 200-0 to 200-N can store prior translations of virtual addresses to physical addresses in a translation lookaside buffer (TLB) to utilize to access data from memory 220 associated with the translated physical addresses. IOMMU 210 could flush the TLB to remove prior address translations and rate limit usage of a device or one or more processors of a device by forcing requests for ATS to be issued instead of permitting reuse of previous address translations.

At (4), one or more of devices 200-0 to 200-N can issue a request to memory 220 to read data stored in translated memory addresses or write data to translated memory addresses. At (5), one or more of devices 200-0 to 200-N can receive read data from memory 220 or an indication of a write completion or failure indication.

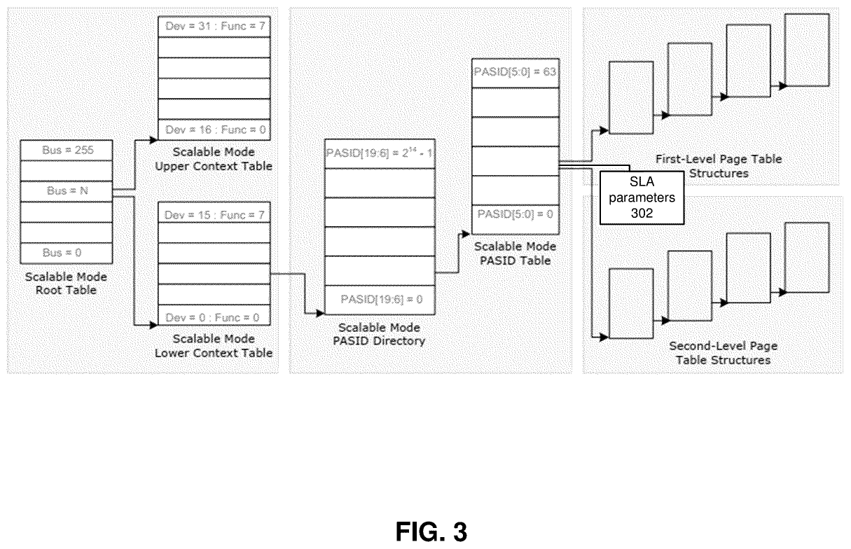

FIG. 3 depicts an example of configuration data. For example, Bus, Device, Function (BDF) parameters can uniquely identify a PCIe function. A PCIe function can be associated with one or more PASID directory tables. In some examples, a PASID directory table can be associated with pointers to SLA parameters 302 including token data for address translations for a PASID (e.g., initial token count for the PASID, token increment values for the PASID per clock cycle, top level token value for the PASID, token utilization for a time interval, or others). An IOMMU can access SLA parameters 302 from host memory to limit a rate of performance of memory address translations. The PASID directory tables and the SLA parameters can be stored in configuration 134, in some examples. An OS or driver can set the PASID directory tables and the SLA parameters during PCIe-connected device enumeration.

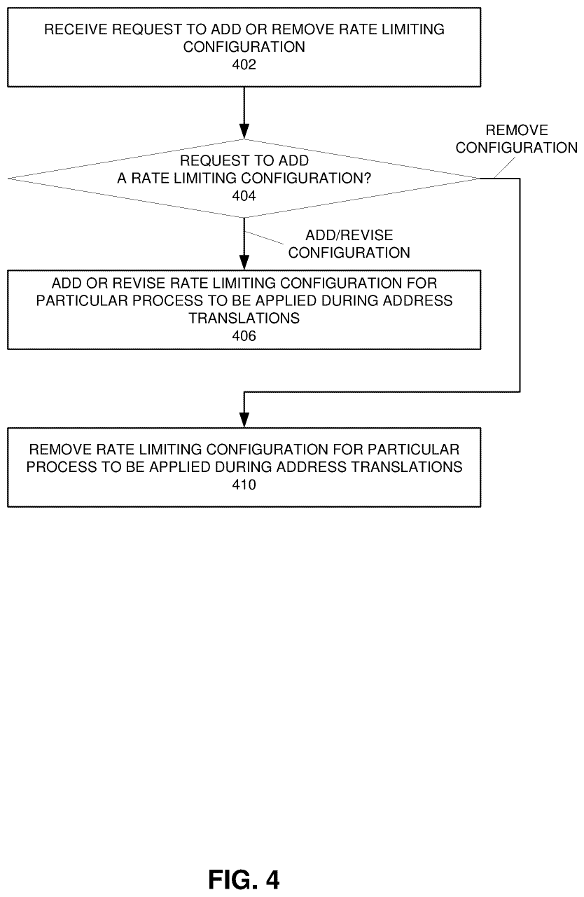

FIG. 4 depicts an example process to configure rate limiting for address translations. At 402, a request to add, revise, or remove an address translation entry can be detected. The request to add, revise, or remove an address translation entry can be a call to an API, as described herein. At 404, a determination can be made as to whether a request is to add, revise, or remove an entry from a configuration for address translation rate limiting. Based on a request to add an entry to a rate limiting configuration, at 406, an entry can be added in the configuration for a particular process. For example, the entry can be added that indicates token parameters for a particular process identifier (e.g., PASID). Token parameters can include initial token count, token increment, peak token value, number of address translations permitted per unit time, or others. For example, the entry can be revised for a particular process identifier to revise one or more of: initial token count, token increment, peak token value, number of address translations permitted per unit time, or others.

At 410, based on the request to remove an entry to a rate limiting configuration, the entry for a particular process identifier indicated by the request can be removed from the configuration. After removal of the configuration for the particular process identifier, request for address translations received for the particular process identifier may not be rate limited.

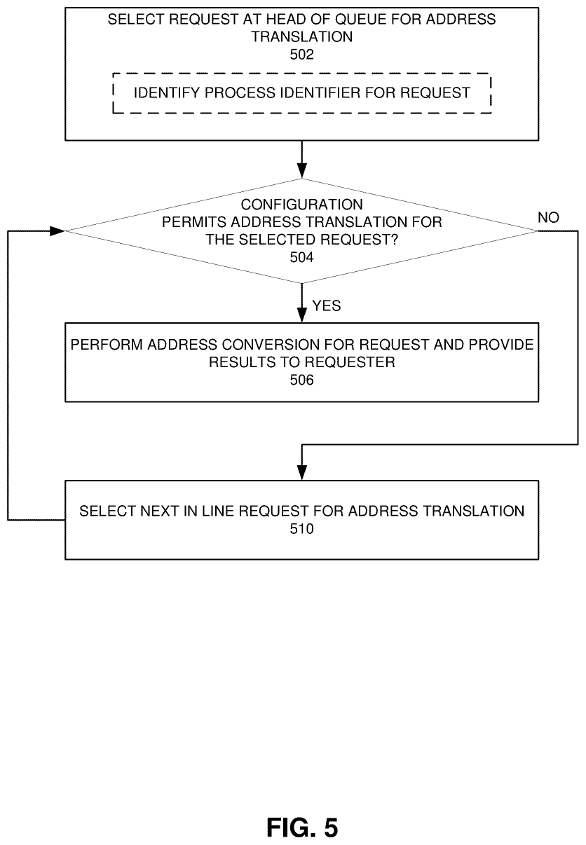

FIG. 5 depicts an example process. The process can be performed by an IOMMU in some examples. At 502, a request to perform an address translation can be identified. For example, the request can be issued by a device to an IOMMU to translate a virtual memory address to a physical memory address for a particular process executed by circuitry or processors of a device. At 504, a determination can be made as to whether the configuration permits address translation for the request. Requests can be processed from least recently received to most recently received. For example, the configuration can permit address translation for the request based on a sufficient number of tokens or credits being available to perform the request for a particular process identifier. For example, the configuration may not permit address translation for the request based on insufficient tokens or credits being available to perform the request for a particular process identifier.

Based on the configuration permitting address translation for the request for the process, at 506, the address conversion can be performed and an address translation provided to the requester device. Based on insufficient tokens or credits being available to perform the request, at 510, the request can be skipped and remain at a head or start of a queue and a next request can be selected. The process can proceed to 504 to determine whether the configuration permits address translation for the next request.

FIG. 6 depicts a system. In some examples, rate limiting of address translation of memory controller 622 or other circuitry can be configured, as described herein. Various examples of a processor socket can include circuitry and software described with respect to FIG. 6. System 600 includes processor 610, which provides processing, operation management, and execution of instructions for system 600. Processor 610 can include any type of microprocessor, central processing unit (CPU), graphics processing unit (GPU), XPU, processing core, or other processing hardware to provide processing for system 600, or a combination of processors. An XPU can include one or more of: a CPU, a graphics processing unit (GPU), general purpose GPU (GPGPU), and/or other processing units (e.g., accelerators or programmable or fixed function FPGAs). Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processor 610 can include multiple processors and multiple processors can be embodied as processor sockets.

In one example, system 600 includes interface 612 coupled to processor 610, which can represent a higher speed interface or a high throughput interface for system components, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610. For example, an accelerator among accelerators 642 can provide data compression (DC) capability, cryptography services such as public key encryption (PKE), cipher, hash/authentication capabilities, decryption, or other capabilities or services. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 620 can include an IOMMU that is configured to perform rate limiting of address translation requests, as described herein. Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

Applications 634 and/or processes 636 can refer instead or additionally to a virtual machine (VM), container (e.g., Docker container), microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

OS 632 can advertise capability of an IOMMU to limit utilization of one or more devices by rate limiting address translations for a particular process identifier across one or more devices (e.g., graphics 640, accelerators 642, memory subsystem 620, or other devices). For example, OS 632 can call an API to configure IOMMU 130 to regulate a rate of address translation operations based on token or credit consumption.

In some examples, OS 632 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers, workstations, or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory. In some examples, packet processing device or network interface device 650 can refer to one or more of: a network interface controller (NIC), a remote direct memory access (RDMA)-enabled NIC, SmartNIC, router, switch, forwarding element, infrastructure processing unit (IPU), or data processing unit (DPU).

In one example, system 600 includes one or more input/output (I/O) interface(s) 660. I/O interface 660 can include one or more interface components through which a user interacts with system 600. Peripheral interface 670 can include any hardware interface not specifically mentioned above. Peripherals refer generally to devices that connect dependently to system 600.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 600 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications. Die-to-die communications can utilize Embedded Multi-Die Interconnect Bridge (EMIB) or an interposer. Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A system in package (SiP) can include a package that encloses one or more of: an SoC, one or more tiles, or other circuitry.

In an example, system 600 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Example 1 includes an apparatus that includes: a device comprising: a host interface; circuitry coupled to the host interface; and second circuitry to limit usage of the circuitry, by a first process, by limiting performance of requests for translation of virtual memory addresses to physical memory addresses, from the first process.

Example 2 includes one or more examples, wherein the circuitry comprises one or more of: a network interface device, an accelerator, memory, or storage.

Example 3 includes one or more examples, wherein the host interface is consistent with Peripheral Component Interconnect Express (PCIe).

Example 4 includes one or more examples, wherein: the second circuitry is to limit usage of the circuitry, by the first process, by limiting performance of requests for translation of virtual memory addresses to physical memory addresses, from the first process based on a priority level of the first process, the second circuitry is to limit usage of the circuitry, by a second process, by limiting performance of requests for translation of virtual memory addresses to physical memory addresses, from the second process, based on a priority level of the second process, and the second circuitry is to prioritize performances of address translation requests from the first process than those of the second process based on the priority level of the first process being higher than the priority level of the second process.

Example 5 includes one or more examples, wherein the second circuitry is to limit usage of the circuitry for service level agreement (SLA) enforcement based on process identifier values.

Example 6 includes one or more examples, wherein the second circuitry comprises an Input-Output Memory Management Unit (IOMMU).

Example 7 includes one or more examples, wherein the second circuitry is to limit usage of multiple devices by the first process.

Example 8 includes one or more examples, wherein a configuration of the second circuitry to limit performance of requests for translation of virtual memory addresses to physical memory addresses is based on a call to an application programming interface (API).

Example 9 includes one or more examples, wherein a configuration of the second circuitry to limit performance of requests for translation of virtual memory addresses to physical memory addresses is based on one or more of: a process identifier value, associated starting token value, token increment amount, ceiling on number of accumulated tokens, or a peak number of tokens utilized per address translation.

Example 10 includes one or more examples, and includes a process of making a Input-Output Memory Management Unit (IOMMU) comprising: forming a first circuitry in the IOMMU and forming a second circuitry in the IOMMU, wherein: the second circuitry in the IOMMU limits usage of the first circuitry by limiting performance of requests for translation of virtual memory addresses to physical memory addresses, from a first process.

Example 11 includes one or more examples, wherein the requests for translation of virtual memory addresses to physical memory addresses comprise requests for Peripheral Component Interconnect Express (PCIe) Address Translation Services (ATS).

Example 12 includes one or more examples, wherein the limiting performance of the requests is based on a number of tokens allocated to the first process.

Example 13 includes one or more examples, wherein a rate of refresh of the tokens allocated to the first process is based on a priority level of the first process.

Example 14 includes one or more examples, wherein the first circuitry comprises one or more of: a network interface device, an accelerator, memory, or storage.

Example 15 includes one or more examples, and includes at least one computer-readable medium, comprising instructions stored thereon, that if executed by one or more processors, cause the one or more processors to: configure a memory management circuitry to rate limit performance of address translation requests received from one or more devices that execute a first process.

Example 16 includes one or more examples, wherein the one or more devices comprise one or more of: a network interface device, an accelerator, memory, or storage.

Example 17 includes one or more examples, comprising instructions stored thereon, that if executed by one or more processors, cause the one or more processors to: configure the memory management circuitry to rate limit performance of address translation requests received from one or more devices that execute a second process, wherein: the memory management circuitry is to prioritize performances of address translation requests from the first process than those of the second process based on a priority level of the first process being higher than a priority level of the second process.

Example 18 includes one or more examples, wherein the memory management circuitry comprises an Input-Output Memory Management Unit (IOMMU).

Example 19 includes one or more examples, wherein the address translation requests comprise requests to translate virtual memory addresses to physical memory addresses.

Example 20 includes one or more examples, wherein the memory management circuitry is to rate limit performance of address translation requests based on credits assigned to the first process.

1. An apparatus comprising:
a device comprising:
a host interface;
circuitry coupled to the host interface; and
second circuitry to limit usage of the circuitry, by a first process, by limiting performance of requests for translation of virtual memory addresses to physical memory addresses, from the first process.

2. The apparatus of claim 1, wherein the circuitry comprises one or more of: a network interface device, an accelerator, memory, or storage.

3. The apparatus of claim 1, wherein the host interface is consistent with Peripheral Component Interconnect Express (PCIe).

4. The apparatus of claim 1, wherein:
the second circuitry is to limit usage of the circuitry, by the first process, by limiting performance of requests for translation of virtual memory addresses to physical memory addresses, from the first process based on a priority level of the first process,
the second circuitry is to limit usage of the circuitry, by a second process, by limiting performance of requests for translation of virtual memory addresses to physical memory addresses, from the second process, based on a priority level of the second process, and
the second circuitry is to prioritize performances of address translation requests from the first process than those of the second process based on the priority level of the first process being higher than the priority level of the second process.

5. The apparatus of claim 1, wherein the second circuitry is to limit usage of the circuitry for service level agreement (SLA) enforcement based on process identifier values.

6. The apparatus of claim 1, wherein the second circuitry comprises an Input-Output Memory Management Unit (IOMMU).

7. The apparatus of claim 1, wherein the second circuitry is to limit usage of multiple devices by the first process.

8. The apparatus of claim 1, wherein a configuration of the second circuitry to limit performance of requests for translation of virtual memory addresses to physical memory addresses is based on a call to an application programming interface (API).

9. The apparatus of claim 1, wherein a configuration of the second circuitry to limit performance of requests for translation of virtual memory addresses to physical memory addresses is based on one or more of: a process identifier value, associated starting token value, token increment amount, ceiling on number of accumulated tokens, or a peak number of tokens utilized per address translation.

10. A process of making a Input-Output Memory Management Unit (IOMMU) comprising:
forming a first circuitry in the IOMMU and
forming a second circuitry in the IOMMU, wherein:
the second circuitry in the IOMMU limits usage of the first circuitry by limiting performance of requests for translation of virtual memory addresses to physical memory addresses, from a first process.

11. The process of claim 10, wherein the requests for translation of virtual memory addresses to physical memory addresses comprise requests for Peripheral Component Interconnect Express (PCIe) Address Translation Services (ATS).

12. The process of claim 10, wherein the limiting performance of the requests is based on a number of tokens allocated to the first process.

13. The process of claim 12, wherein a rate of refresh of the tokens allocated to the first process is based on a priority level of the first process.

14. The process of claim 10, wherein the circuitry comprises one or more of: a network interface device, an accelerator, memory, or storage.

15. At least one computer-readable medium, comprising instructions stored thereon, that if executed by one or more processors, cause the one or more processors to:
configure a memory management circuitry to rate limit performance of address translation requests received from one or more devices that execute a first process.

16. The computer-readable medium of claim 15, wherein the one or more devices comprise one or more of: a network interface device, an accelerator, memory, or storage.

17. The computer-readable medium of claim 15, comprising instructions stored thereon, that if executed by one or more processors, cause the one or more processors to:
configure the memory management circuitry to rate limit performance of address translation requests received from one or more devices that execute a second process, wherein:
the memory management circuitry is to prioritize performances of address translation requests from the first process than those of the second process based on a priority level of the first process being higher than a priority level of the second process.

18. The computer-readable medium of claim 15, wherein the memory management circuitry comprises an Input-Output Memory Management Unit (IOMMU).

19. The computer-readable medium of claim 15, wherein the address translation requests comprise requests to translate virtual memory addresses to physical memory addresses.

20. The computer-readable medium of claim 15, wherein the memory management circuitry is to rate limit performance of address translation requests based on credits assigned to the first process.
